(19) United States
(12) Patent Application Publication
(10) Pub. No.: US 2017/0117004 A1
(43) Pub. Date: Apr. 27, 2017

(54) METHOD AND APPARATUS FOR ALERTING USER TO SOUND OCCURRENCE

(71) Applicant: UFIRST INC., Ansan-si (KR)

(72) Inventor: Hyun Sang LEE, Seongnam-si (KR)

(21) Appl. No.: 15/298,745

(22) Filed: Oct. 20, 2016

(30) Foreign Application Priority Data
Oct. 26, 2015 (KR) 10-2015-0148985
Mar. 7, 2016 (KR) 10-2016-0026831

(51) Int. Cl. G10L 25/51; H04R 1/10

(52) U.S. Cl. CPC G10L 25/51; H04R 1/1075; H04R 2460/13

(57) ABSTRACT

According to an embodiment of the present disclosure, a method for providing a notification through a sound alerting apparatus comprises determining whether sensitivities of ambient sounds respectively received through sound sensors are a preset vibration reference sensitivity or higher, calculating a gap between the sensitivities when the sensitivities are the preset vibration reference sensitivity or higher, and operate at least one of vibration generators according to the gap to alert a user to a sound occurrence.

### CROSS-REFERENCE TO RELATED APPLICATIONS

This patent application claims priority under 35 U.S.C. §119 to Korean Patent Application No. 10-2015-0148985, filed on Oct. 26, 2015 and No. 10-2016-0026831, filed on Mar. 7, 2016 in the Korean Intellectual Property Office, the disclosure of which is incorporated by reference herein in its entirety.

### TECHNICAL FIELD

The present disclosure relates to hearing aids, and more specifically, to an apparatus and method for alerting the user of a sound occurrence.

### DISCUSSION OF RELATED ART

There are many types of hearing aids (also known as hearing instruments), which vary in size, power, and circuitry, such as body worn aids, behind-the-ear aids, on-the-ear aids, CRTs, and so on. However, such conventional types of hearing aids, by their inherent nature, fails to consider the degree or level of hearing loss the user suffers, requiring the user to wear on all the time not to miss sounds that should be not. This causes tremendous inconvenience to the user. Therefore, a need exists for a new approach that may eliminate such inconvenience.

### SUMMARY

According to an embodiment of the present disclosure, a method for providing a notification through a sound alerting apparatus comprises determining whether sensitivities of ambient sounds respectively received through sound sensors are a preset vibration reference sensitivity or higher, calculating a gap between the sensitivities when the sensitivities are the preset vibration reference sensitivity or higher, and operating at least one of vibration generators according to the gap to alert a user to a sound occurrence.

When the gap is a predetermined value or less, the vibration generators may be operated to alert the user to the sound occurrence, and when the gap is higher than the predetermined value, a direction of one receiving a higher sensitivity of sound of the sound sensors may be identified.

One of the vibration generators which is disposed corresponding to the sound sensor receiving the higher sensitivity of sound may be operated to alert the user to the sound occurrence in the identified direction.

At least one of the vibration generators may be operated according to a preset vibration strength and time to alert the user to the sound occurrence.

The method may further comprise outputting each of the ambient sounds through an earphone.

According to an embodiment of the present disclosure, a sound alerting apparatus comprises microphones receiving and processing ambient sounds, vibration generators each operated under a control signal to generate a vibration, and a controller determining whether sensitivities of the ambient sounds respectively received from the microphones are a preset vibration reference sensitivity or higher, calculating a gap between the sensitivities when the sensitivities are the preset vibration reference sensitivity or higher, and operating at least one of the vibration generators according to the gap to alert a user to a sound occurrence.

When the gap is a predetermined value or less, the controller may operate the vibration generators to alert the user to the sound occurrence, and when the gap is higher than the predetermined value, the controller may identify a direction of one receiving a higher sensitivity of sound of the sound sensors.

The controller may operate one of the vibration generators which is disposed corresponding to the sound sensor receiving the higher sensitivity of sound to alert the user to the sound occurrence in the identified direction.

The controller may operate at least one of the vibration generators according to a preset vibration strength and time to alert the user to the sound occurrence.

The sound alerting apparatus may further comprise an earphone outputting each of the ambient sounds to the user.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a view illustrating a network configuration for a system for providing a notification according to an embodiment of the present disclosure;

FIG. 2 is a block diagram illustrating a sound alerting apparatus according to an embodiment of the present disclosure;

FIGS. 3 to 5 are views illustrating a sound alerting apparatus implemented as a neckband according to an embodiment of the present disclosure;

FIG. 6 is a view illustrating a sound alerting apparatus implemented as a clip according to an embodiment of the present disclosure;

FIGS. 7 and 8 are views illustrating screenshots of an application running on a terminal according to an embodiment of the present disclosure.

### DETAILED DESCRIPTION OF EXEMPLARY EMBODIMENTS

Hereinafter, exemplary embodiments of the inventive concept will be described in detail with reference to the accompanying drawings. Like reference denotations may be used to refer to like or similar elements throughout the specification and the drawings. The inventive concept, however, may be modified in various different ways, and should not be construed as limited to the embodiments set forth herein. As used herein, the singular forms “a,” “an,” and “the” are intended to include the plural forms as well, unless the context clearly indicates otherwise. It will be understood that when an element or layer is referred to as being “on” “connected to,” “coupled to,” or “adjacent to” another element or layer, it can be directly on, connected, coupled, or adjacent to the other element or layer, or intervening elements or layers may be present.

FIG. 1 is a view illustrating a network configuration for a system for providing a notification according to an embodiment of the present disclosure.

The system for providing a notification (hereinafter, simply referred to as a “system”) or the sound alerting apparatus according to the present disclosure may be more readily and usefully intended for hearing-impaired persons, but embodiments of the present disclosure are not essentially limited thereto.

Referring to FIG. 1, the system includes a sound alerting apparatus 100 and a terminal 200.

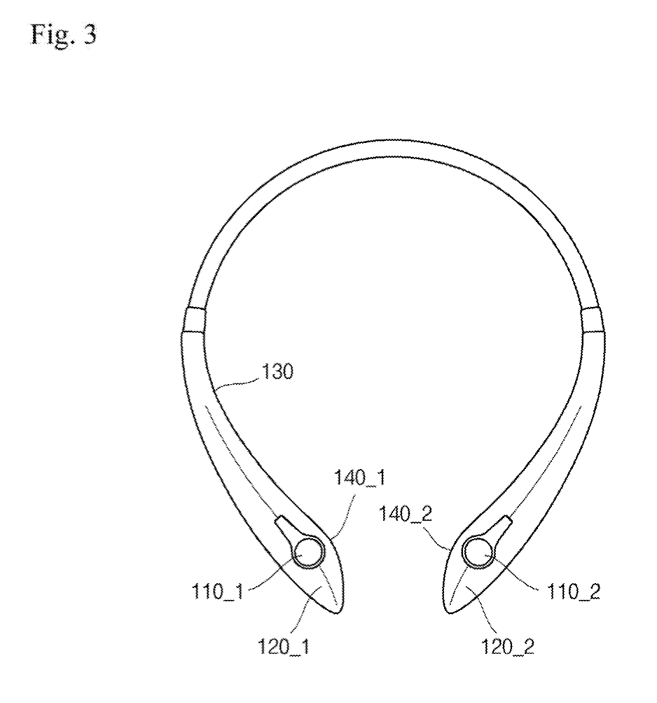

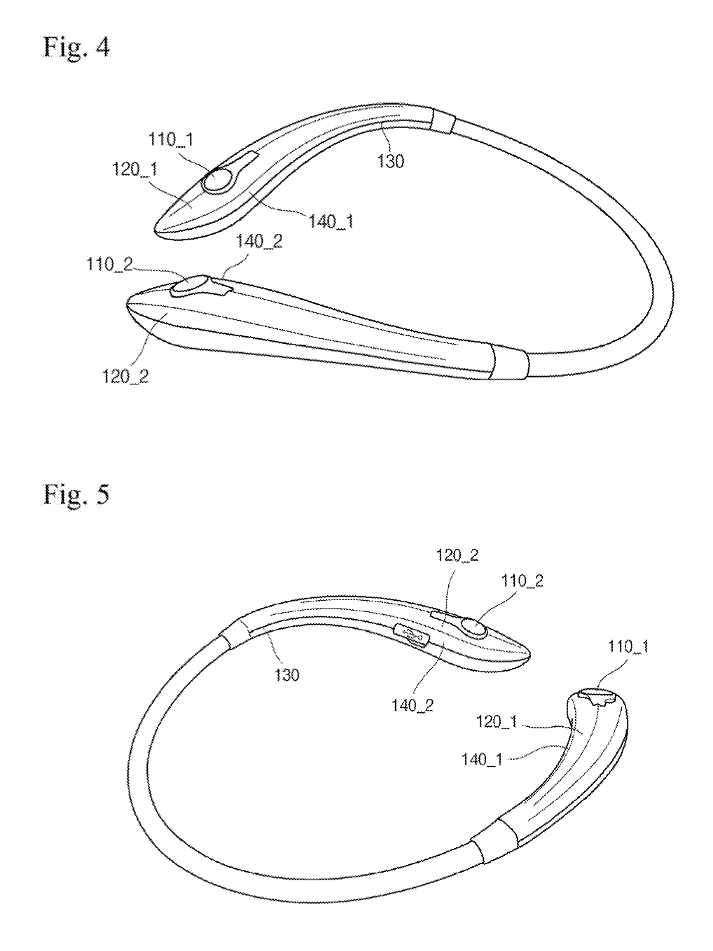

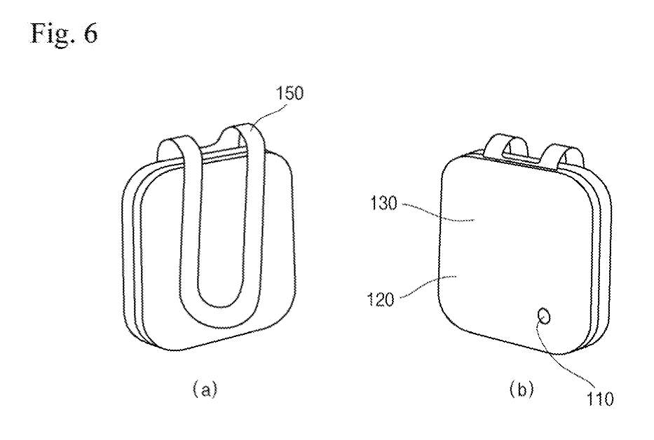

The sound alerting apparatus 100 may sense an ambient sound, analyze the sound, and operate according to the sensitivity of the sound and operation setting information received from the terminal 200. The sound alerting apparatus 100 may be configured as a neckband-type headphone as shown in FIGS. 3 to 5 or a clip as shown in FIG. 6.

An example in which the sound alerting apparatus 100 is implemented and operated as a neckband-type headphone is described below in detail with reference to FIGS. 3 to 5, and an example in which the sound alerting apparatus 100 is implemented and operated as a clip is described below in detail with reference to FIG. 6.

The sound alerting apparatus 100 may sense an ambient sound, compare the sensitivity of the sound with a vibration reference sensitivity included in the operation setting information, and operates a vibration generator according to a result of the comparison.

According to an embodiment of the present disclosure, when the sensitivity of the ambient sound is the reference sensitivity or higher, the sound alerting apparatus 100 operates the vibration generator to alert the user to a sound occurrence.

There may be provided a plurality of vibration generators, e.g., two vibration generators.

The sound alerting apparatus 100 may calculate a gap in sensitivity between sounds respectively received from sound sensors and may operate all or some of the plurality of vibration generators depending on whether the sensitivity gap between the received sound is a predetermined value or higher, alerting the user to a sound occurrence.

When the sensitivity gap between the sounds respectively received from the sound sensors is the predetermined value or higher, the sound alerting apparatus 100 may identify the direction of a sound sensor from which a higher-sensitivity sound is received among the sound sensors and operate the vibration generator corresponding to the direction, alerting the user to a sound occurrence in the direction.

The sound alerting apparatus 100 generates a vibration according to a vibration time and strength previously set by the user when operating the vibration generator.

For example, when the sensitivity of an ambient sound received, e.g., a honk, doorbell sound, or baby cry, is higher than a sound sensitivity previously set by the user, the user may be alerted to the direction. This may benefit the user, especially when the user suffers from a hearing loss or impairment.

When the sensitivity gap between the sounds received from the sound sensors is the predetermined value or lower, the sound alerting apparatus 100 may determine that the sounds respectively received from the sound sensors have a similar sensitivity and operate all of the vibration generators, alerting the user to a sound occurrence.

The terminal 200 may be a terminal carried by the user using the sound alerting apparatus 100, which may be implemented as a personal digital assistant (PDA), cellular or mobile phone, or smartphone, or any other various portable devices.

The terminal 200 may have an application previously installed thereon to set or control operations of the sound alerting apparatus 100. Alternatively, the terminal 200 may download the application through a predetermined route, e.g., from a server.

The application may automatically run when the sound alerting apparatus 100 is connected with the terminal 200 via, e.g., wireless communication (e.g., Bluetooth, ZigBee, or Wi-Fi, or infrared (IR)) or wired communication.

The application may provide a process for configuring the operation setting information of the sound alerting apparatus 100, enabling the user to set an operation of the sound alerting apparatus 100. The operation setting information of the sound alerting apparatus 100 may include a vibration reference sensitivity, a vibration time, a sound sensitivity gap, and a vibration strength.

The vibration reference sensitivity, as used herein, may mean a sensitivity serving as a reference for generating a vibration depending on the sensitivity of an ambient sound recognized. The vibration reference sensitivity may be set by the user or may be automatically on the application. When set automatically on the application, the vibration reference sensitivity may be determined in reference to a per-sound sensitivity context information table. The per-sound sensitivity context information table may be a table retaining context information per sound sensitivity.

For example, the per-sound sensitivity context information table may store information indicating that, when the sensitivity of a baby cry is level 1, the baby babbles, information indicating that, when the sensitivity of a baby cry is level 3, the bay is hungry and asks to change diapers, and information indicating that, when the sensitivity of the baby cry is level 5, the baby is under emergency.

The vibration reference sensitivity may be recommended on the application. For example, the terminal 200 may receive the type of a sound required to be alerted from the user, extract a sound required by the user in reference to the per-sound sensitivity context information table, set the vibration reference sensitivity to a mean value of sensitivities corresponding to context information required to be alerted using the per-sound sensitivity context information, and recommend the vibration reference sensitivity for the user.

The vibration time, as used herein, may mean a time when the sound alerting apparatus 100 is required to generate a vibration when the sensitivity of an ambient sound received is the vibration reference sensitivity or higher.

The sound sensitivity gap, as used herein, may mean a gap or difference in sensitivity between sounds respectively received from or through the sound sensors disposed in the sound alerting apparatus 100. The reason for setting the sound sensitivity gap is to operate all or only some of the vibration generators disposed in the sound alerting apparatus 100 by determining whether the sound sensitivity gap is a predetermined value or higher or lower.

When the sound sensitivity gap is a predetermined value or higher, the vibration generator positioned in the direction where a higher sound sensitivity is measured among the vibration generators in the sound alerting apparatus 100 is operated to alert the user to a sound occurrence in the direction. When the sound sensitivity gap is the predetermined value or lower, all of the vibration generators in the sound alerting apparatus 100 are operated to alert the user to a sound occurrence.

The vibration strength, as used herein, may mean the strength of a vibration generated by the sound alerting apparatus 100 when the sensitivity of an ambient sound received is the vibration reference sensitivity or higher.

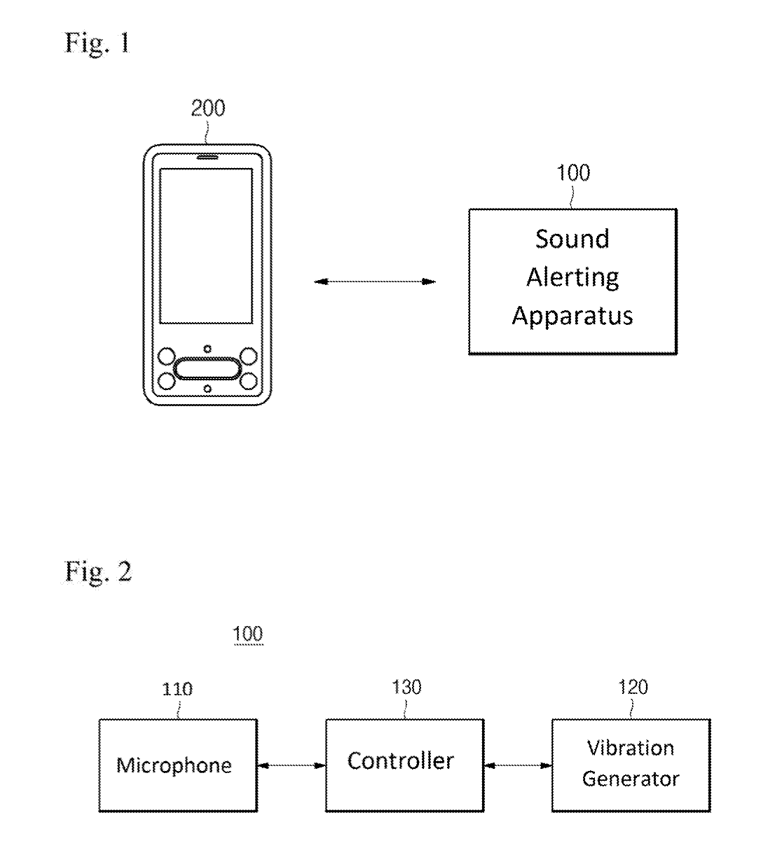

FIG. 2 is a block diagram illustrating a sound alerting apparatus according to an embodiment of the present disclosure.

Referring to FIG. 2, the sound alerting apparatus 100 includes a microphone 110, a vibration generator 120, and a controller 130.

The microphone 110 may receive and signal-process an ambient sound and provides the signal-processed sound to the controller 130.

Although the microphone 110 and the vibration generator 120 each are shown in a single block, there may be provided a plurality of microphones 110 (e.g., two microphones 110) and a plurality of vibration generators 120 (e.g., two vibration generators 120).

Each of the vibration generators 120 generates a vibration of a predetermined strength for a predetermined time under the control of the controller 130.

The vibration generator 120 may be disposed on the sound alerting apparatus 100, corresponding to the direction of the microphone 110.

The controller 130 may measure the sensitivity of a sound received through the microphone 110, compare the sensitivity of the sound with a preset vibration reference sensitivity, and operate the vibration generator 120 depending on a result of the comparison.

According to an embodiment of the present disclosure, when the sensitivity of the sound is the vibration reference sensitivity or higher, the controller 130 may operate to alert the user to a sound occurrence.

The controller 130 may calculate a gap in sensitivity between the sounds respectively received from the microphones 110 and operate all or some of the vibration generators 120 depending on whether the sound sensitivity gap is a predetermined value or higher, alerting the user to a sound occurrence.

When the gap in sensitivity between the sounds respectively received from the microphones 110 is the predetermined value or higher, the controller 130 may identify the direction of the microphone 110 through which a higher sensitivity of sound is received among the microphones 110 and operate the vibration 120 corresponding to the direction to alert the user to a sound occurrence in the direction.

The controller 130 may operate each vibration generator 120 to generate a vibration depending on a vibration time and strength previously set by the user.

For example, when the sensitivity of an ambient sound received, e.g., a honk, doorbell sound, or baby cry, is higher than a sound sensitivity previously set by the user, the direction may be known to the user through the vibration, helping the user, e.g., when the user suffers from a hearing loss.

FIGS. 3 to 5 are views illustrating a sound alerting apparatus implemented as a neckband according to an embodiment of the present disclosure.

Referring to FIGS. 3 to 5, the sound alerting apparatus 100 may be configured or implemented to be wearable on the user's neck.

Referring to FIG. 3, the sound alerting apparatus 100 includes a first microphone 110_1 and a second microphone 110_2 respectively positioned at both sides of the user's neck, a first vibration generator 120_1 disposed corresponding to a direction of the first microphone 110_1 and a second vibration generator 120_2 disposed corresponding to a direction of the second microphone 110_2, and a controller 130. The sound alerting apparatus 100 may further include a first hearing-aid earphone 140_1 and a second hearing-aid ear phone 140_2.

The first microphone 110_1 and the second microphone 110_2 each may receive an ambient sound, signal-process the ambient sound, and provide the signal-processed sound to the controller 130.

The first vibration generator 120_1 and the second vibration generator 120_2 may be simultaneously operated under the control of the controller 130 to generate vibrations, or only one of the first vibration generator 120_1 and the second vibration generator 120_2 may be generated under the control of the controller 130 to generate a vibration.

The controller 130 may measure the sensitivity of sounds received through the first microphone 110_1 and the second microphone 110_2, compare the sound sensitivity with a preset vibration reference sensitivity, and operate the first vibration generator 120_1 and the second vibration generator 120_2 according to a result of the comparison.

According to an embodiment of the present disclosure, when the sound sensitivity is the vibration reference sensitivity or higher, the controller 130 may operate at least one of the first vibration generator 120_1 and the second vibration generator 120_2 to alert the user to the occurrence of the sounds.

The controller 130 may calculate a gap in sensitivity between sounds respectively received from the first microphone 110_1 and the second microphone 110_2 and may operate all or one of the first vibration generator 120_1 and the second vibration generator 120_2 depending on whether the sound sensitivity gap is a predetermined value or higher, alerting the user to a sound occurrence.

When the gap in sensitivity between the sounds respectively received from the first microphone 110_1 and the second microphone 110_2 is the predetermined value or higher, the controller 130 may identify the direction of the microphone from which a higher sensitivity of sound is received of the first microphone 110_1 and the second microphone 110_2 and operates the vibration generator corresponding to the direction, alerting the user to a sound occurrence in the direction.

For example, when a higher sensitivity of sound is received through the first microphone 110_1 than the second microphone 110_2, the controller 130 may operate the first vibration generator 120_1 disposed corresponding to the direction of the first microphone 110_1, alerting the user to a sound occurrence in the direction.

As another example, when a higher sensitivity of sound is received through the second microphone 110_2 than the first microphone 110_1, the controller 130 operates the second vibration generator 120_2 disposed corresponding to the direction of the second microphone 110_2, alerting the user to a sound occurrence in the direction.

The first hearing-aid earphone 140_1 and the second hearing-aid earphone 140_2, respectively, output sounds received from the first microphone 110_1 and the second microphone 110_2. The first hearing-aid earphone 140_1 and the second hearing-aid earphone 140_2 each may function as hearing aids or provide a hearing-aid function, as does a general hearing-aid device, thus eliminating the need for the user to keep wearing the earphone.

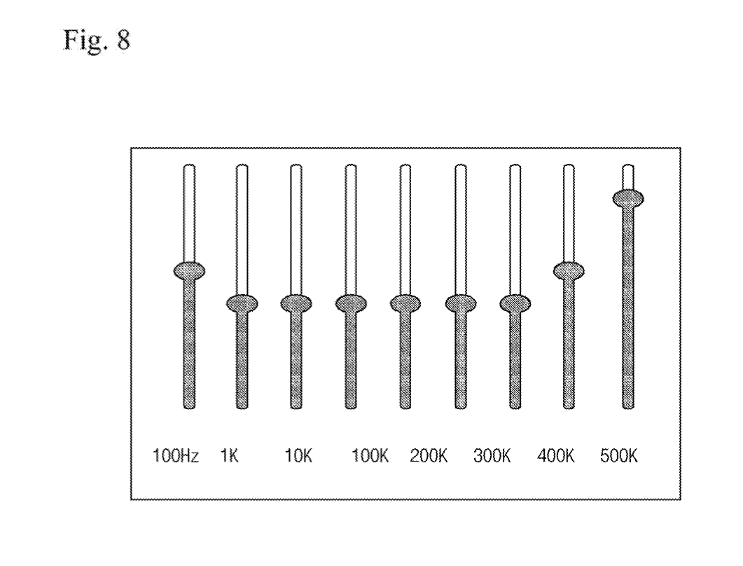

The first hearing-aid earphone 140_1 and the second hearing-aid earphone 140_2 each may have a voice band spectrum set by the user through a process described below in connection with FIG. 8, and each may operate according to the voice band spectrum to provide the user with the functionality of a common hearing-aid device.

FIG. 6 is a view illustrating a sound alerting apparatus implemented as a clip according to an embodiment of the present disclosure.

Referring to FIG. 6, the sound alerting apparatus 100 may be implemented in a clip shape to be wearable on a particular portion of the user.

Referring to (a) of FIG. 6, the sound alerting apparatus 100 implemented as a clip may be attached or fastened to a portion of the user's clothes. Referring to (b) of FIG. 6, the sound alerting apparatus 100 includes a microphone 110, a vibration generator 120, and a controller 130.

The microphone 110 receives an ambient sound, signal-processes the sound, and provides the signal-processed sound to the controller 130.

There may be provided a plurality of vibration generators 120, e.g., two vibration generators.

The plurality of vibration generators 120 may be simultaneously operated under the control of the controller 130 to generate vibrations.

The controller 130 may measure the sensitivity of the sound received through the microphone 110, compare the sound sensitivity with a preset vibration reference sensitivity, and operate the vibration generator 120 according to a result of the comparison.

According to an embodiment of the present disclosure, when the sensitivity of an ambient sound received is a sound sensitivity set by the user or higher, a direction may be known to the user through a vibration, helping the user who is, e.g., a hearing-impaired person.

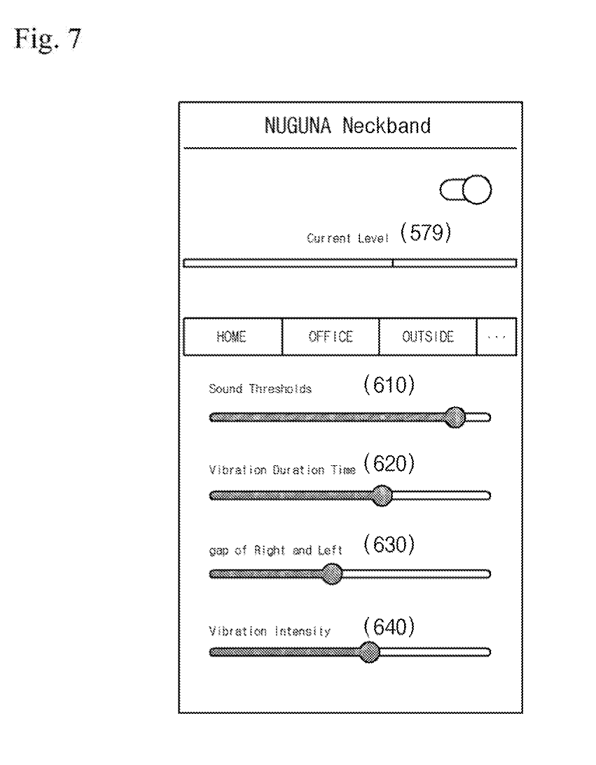

FIGS. 7 and 8 are views illustrating screenshots of an application running on a terminal according to an embodiment of the present disclosure.

Referring to FIGS. 7 and 8, the terminal 200 may have an application previously installed thereon, enabling settings of operations of the sound alerting apparatus 100. Alternatively, the application may be downloaded through a predetermined route (e.g., from a server) and installed on the terminal 200.

The application may be automatically run when the sound alerting apparatus 100 is connected with the terminal 200 via wireless communication (e.g., Bluetooth, ZigBee, Wi-Fi, or IR transmission) or wired communication.

The application may provide a process for configuring operation setting information of the sound alerting apparatus 100, allowing the user to set operations of the sound alerting apparatus 100. The operation setting information of the sound alerting apparatus 100 may include a vibration reference sensitivity 610, a vibration time 620, a sound sensitivity gap 630, and a vibration strength 640.

The vibration reference sensitivity 610 may mean a sensitivity serving as a reference for generating a vibration depending on the sensitivity of an ambient sound recognized. The vibration reference sensitivity 610 may be set by the user or may be automatically on the application. When set automatically on the application, the vibration reference sensitivity 610 may be determined in reference to a per-sound sensitivity context information table. The per-sound sensitivity context information table may be a table retaining context information per sound sensitivity.

For example, the per-sound sensitivity context information table may store information indicating that, when the sensitivity of a baby cry is level 1, the baby babbles, information indicating that, when the sensitivity of a baby cry is level 3, the bay is hungry and asks to change diapers, and information indicating that, when the sensitivity of the baby cry is level 5, the baby is under emergency.

The vibration reference sensitivity 610 may be recommended on the application. For example, the terminal 200 may receive the type of a sound required to be alerted from the user, extract a sound required by the user in reference to the per-sound sensitivity context information table, set the vibration reference sensitivity 610 to a mean value of sensitivities corresponding to context information required to be alerted using the per-sound sensitivity context information, and recommend the vibration reference sensitivity for the user.

The vibration time 620 may mean a time when the sound alerting apparatus 100 is required to generate a vibration when the sensitivity of an ambient sound received is the vibration reference sensitivity 610 or higher.

The sound sensitivity gap 630 may mean a difference in sensitivity between sounds respectively received through the sound sensors disposed in the sound alerting apparatus 100. The reason for setting the sound sensitivity gap 630 is to operate all or only some of the vibration generators disposed in the sound alerting apparatus 100 by determining whether the sound sensitivity gap 630 is a predetermined value or higher or lower.

The vibration strength 640 may mean the strength of a vibration generated by the sound alerting apparatus 100 when the sensitivity of an ambient sound received is the vibration reference sensitivity 610 or higher.

The application running on the terminal 200 may be configured to set a hearing-aid earphone (e.g., the first hearing-aid earphone 140_1 or second hearing-aid earphone 140_2 shown in FIGS. 3 to 6) as illustrated in FIG. 8, allowing for settings of a voice band spectrum of a sound at which the user who is a hearing-impaired person is difficult to hear so that the hearing-aid earphone is operated according to the set voice band spectrum to function as a hearing aid.

While the inventive concept has been shown and described with reference to exemplary embodiments thereof, it will be apparent to those of ordinary skill in the art that various changes in form and detail may be made thereto without departing from the spirit and scope of the inventive concept as defined by the following claims.

What is claimed is:

1. A method for providing a notification through a sound alerting apparatus, the method comprising:
determining whether sensitivities of ambient sounds respectively received through sound sensors are a preset vibration reference sensitivity or higher;
calculating a gap between the sensitivities when the sensitivities are the preset vibration reference sensitivity or higher; and
operate at least one of vibration generators according to the gap to alert a user to a sound occurrence.

2. The method of claim 1, wherein when the gap is a predetermined value or less, the vibration generators are operated to alert the user to the sound occurrence, and when the gap is higher than the predetermined value, a direction of one receiving a higher sensitivity of sound of the sound sensors is identified.

3. The method of claim 2, wherein one of the vibration generators which is disposed corresponding to the sound sensor receiving the higher sensitivity of sound is operated to alert the user to the sound occurrence in the identified direction.

4. The method of claim 1, wherein at least one of the vibration generators is operated according to a preset vibration strength and time to alert the user to the sound occurrence.

5. The method of claim 1, further comprising outputting each of the ambient sounds through an earphone.

6. A sound alerting apparatus, comprising:
microphones receiving and processing ambient sounds;
vibration generators each operated under a control signal to generate a vibration; and
a controller determining whether sensitivities of the ambient sounds respectively received from the microphones are a preset vibration reference sensitivity or higher, calculating a gap between the sensitivities when the sensitivities are the preset vibration reference sensitivity or higher, and operating at least one of the vibration generators according to the gap to alert a user to a sound occurrence.

7. The sound alerting apparatus of claim 6, wherein when the gap is a predetermined value or less, the controller operates the vibration generators to alert the user to the sound occurrence, and when the gap is higher than the predetermined value, the controller identifies a direction of one receiving a higher sensitivity of sound of the sound sensors.

8. The sound alerting apparatus of claim 7, wherein the controller operates one of the vibration generators which is disposed corresponding to the sound sensor receiving the higher sensitivity of sound to alert the user to the sound occurrence in the identified direction.

9. The sound alerting apparatus of claim 6, wherein the controller operates at least one of the vibration generators according to a preset vibration strength and time to alert the user to the sound occurrence.

10. The sound alerting apparatus of claim 6, further comprising an earphone outputting each of the ambient sounds to the user.
